(19) United States
(12) Patent Application Publication
(10) Pub. No.: US 2010/0143663 A1
(43) Pub. Date: Jun. 10, 2010

(54) Reflective Metal Polymeric Insulation Material

(76) Inventor: Furio Orologio, Etobicoke (CA)

Correspondence Address: MANELLI DENISON & SELTER, 2000 M STREET NW SUITE 700, WASHINGTON, DC, 20036-3307, US

(21) Appl. No.: 12/704,554

(22) Filed: Feb. 12, 2010

Related U.S. Application Data
(63) Continuation-in-part of application No. 12/425,415, filed on Apr. 17, 2009.

(30) Foreign Application Priority Data
Apr. 24, 2008 (CA) 2,629650

(51) Int. Cl. B32B 3/12; B32B 37/00

(52) U.S. Cl. 428/178; 156/60

(57) ABSTRACT

A reflective metal polymeric insulation bubble pack assembly comprising a first reflective metal bubble pack; a second reflective metal bubble pack; and a first plurality of intervening bubble spaces suitably located between the first and the second bubble packs as to define at least one inner insulative air chamber between the first and second bubble packs. The invention provides a non-fiberglass improved R-value insulation material that is cost-effective in material, labour, production and installation costs relative to prior art materials.

This application is a continuation-in-part of U.S. patent application Ser. No. 12/425,415, filed on Apr. 17, 2009.

### FIELD OF THE INVENTION

This invention relates to reflective metal polymeric insulation material, particularly, metalized and metal laminated bubble pack insulation material for use as packaging, and in vehicles, and, more particularly, in residential, commercial and industrial buildings and establishments comprising a framed structure, walls, crawl spaces and the like, and wrapping for water heaters, pipes and the like; and most particularly insulation for ducts carrying warm or cold air in said buildings and establishments.

### BACKGROUND OF THE INVENTION

Ducts carrying warm or cold air throughout buildings are presently insulated to a R6 value code standard. One established insulation material used to surround ducts is fiberglass wherein the R6 value is obtained by wrapping a sufficiently thick layer of the fiberglass around the duct.

Insulation materials are known which comprise a clean, non-toxic, heat barrier made of aluminum foil bonded to polymeric materials or an aluminized PET (polyethylene terephthalate) layer. Examples of such insulation materials, includes aluminum foil backing with foam materials selected from closed cell foams, polyethylene foams, polypropylene foams and expanded polystyrene foams (EPS).

Alternative insulation materials in commercial use are made from laminated aluminum foil or aluminized film bonded to a single or double layer of polyethylene-formed bubbles spaced one bubble from another bubble in so-called “bubble-pack” arrangements. Metal foil laminate or metalized film bubble-packs are used as thermal insulation in wood frame structures, walls, attics, crawl spaces, basements and the like and as wrapping for hot water heaters, hot and cold water pipes, air ducts and the like. The reflective surface of the metal enhances the thermal insulation of the air-containing bubble pack.

In prior art reflective metal insulation for ducting and the like, metal laminated or metalized film bubbled pack material is wrapped around sections of the duct spaced perpendicular to the length of the duct from the sides of the duct generally by suitably shaped foam corner spacers and/or intermittent rectangular 4-8 cm wide inner foam spacers to create an inner air space insulation barrier.

However, to-date, although a R6 value can be achieved by known reflective metal laminate and metalized bubble pack wrapping of air ducts, an insulation value of greater than R6 has, to-date, not been achieved.

While enhanced R-value metal reflective bubble pack wrapping systems for air ducts and the like could be built up as individual bubble pack layers one upon another with additional air space barriers between the packs lengthwise of the duct, this is generally not commercially practicable because of the additional labour installation costs and hastle.

There is, therefore, a need for a non-fiberglass improved R-value insulation material acceptable to the field, particularly of at least R8.

### SUMMARY OF THE INVENTION

It is an object of the present invention to provide a non-fiberglass improved R-value insulation material that is cost-effective in material, labour, production and installation costs relative to prior art materials.

Accordingly, the invention provides in one broad aspect a reflective metal polymeric insulation bubble pack assembly comprising a first reflective metal bubble pack; a second reflective metal bubble pack; and a first plurality of intervening bubble spaces suitably located between said first and said second bubble packs as to define at least one inner insulative air chamber between said first and second bubble packs.

Preferably, the invention provides a bonded assembly comprising

said first reflective metal bubble pack;

said second reflective metal bubble pack;

said first plurality of intervening bubble spacers;

a third reflective metal bubble pack;

and a second plurality of intervening bubble spacers suitably located between said second bubble pack and said third bubble pack as to define at least one inner insulative air chamber between said second and said third bubble packs.

The invention preferably provides a bubble pack assembly, as hereinabove defined, wherein each of said reflective metal bubble packs comprises a metalized polymer film or a metal foil polymer laminate.

Preferably, the invention provides an assembly, as hereinabove defined, wherein said first reflective metal bubble pack and said second reflective metal bubble pack are independently selected from the group consisting of

(A) a bubble pack comprising a bubble film having a first face and a second face; a first film laminated to said first face; a second film laminated to said second face; and a first metalized film laminated to said first film;
(B) a bubble pack comprising a bubble pack comprising a bubble film having a first face and a second face; a first film laminated to said first face; a second film laminated to said second face; a first metalized film laminated to said first film, and a second metalized film laminated to said second film;
(C) a bubble pack comprising a bubble film having a first face and a second face; a first film laminated to said first face; and a metalized film laminated to said first film;
(D) a bubble pack comprising

(i) a first bubble film having a first bubble first face and a first bubble second face; a first film laminated to said first bubble first face and a first bubble second face; and a first metalized film laminated to said first bubble first face;

(ii) a second bubble film having a second bubble first face and a second bubble second face; a second film laminated to said second bubble first face; and a second metalized film laminated to said second bubble second face; and

(iii) an intervening film laminated to said first bubble second face and to second bubble first face whereby said first bubble film and said second bubble film are laminated one to the other.

In alternative preferments, the invention provides an assembly, as hereinabove defined, wherein said first reflective metal bubble pack and said second reflective metal bubble pack are independently selected from the group consisting of

(A) a bubble pack comprising a bubble film having a first face and a second face; a first film laminated to said first face; a second film laminated to said second face; and a first metal foil laminated to said first film;
(B) a bubble pack comprising a bubble film having a first face and a second face; a first film laminated to said first face; a second film laminated to said second face; a first metal foil laminated to said first film and a second metal foil laminated to said second film;
(C) a bubble pack comprising a bubble film having a first face and a second face; and a first film laminated to said first face; and a metal foil laminated to said first film;
(D) a bubble pack comprising

(i) a first bubble film having a first bubble first face and a first bubble second face; a first film laminated to said first bubble first face and a first bubble second face; and a first metal foil laminated to said first bubble first face;

(ii) a second bubble film having a second bubble first face and a second bubble second face; a second film laminated to said second bubble first face; and a second metal foil laminated to said second bubble second face; and

(iii) an intervening film laminated to said first bubble second face and to second bubble first face whereby said first bubble film and said second bubble film are laminated one to the other.

Preferably, the invention provides a bubble pack assembly, as hereinabove defined, further comprising at least one intervening inner metal foil or metalized film disposed within at least one of said at least one inner insulative air chamber between said first and second bubble packs.

Preferably, the invention provides in a further aspect a metalized polymeric film reflective insulation bubble pack assembly comprising

(A) a first bubble layer having an inner face and an outer face;

a first film selected from a metalized film and metal foil laminate having an inner face laminated to said outer face of said first bubble layer and an outer face,

(B) a second bubble layer having an inner face and an outer face, a second film selected from a metalized film and a metal laminate having an inner face laminated to said outer face of said second bubble layer, and an outer face,
(C) an intervening inner metal foil or metalized film having a first face and a second face disposed between said first bubble layer and said second bubble layer,
(D) a pair of bubble spacers suitably located between said inner face of said first bubble layer and said first face of said intervening inner metalized film as to define an inner insulative air chamber between said first bubble layer, said intervening inner metalized film and said spacers.

In further embodiments, an assembly as hereinabove defined further comprises at least one more additional spacer suitably located between said first bubble layer and said intervening inner foil or metalized film as to define at least one more inner insulative air chamber.

In further embodiments, an assembly as hereinabove defined further comprises at least one more additional spacer suitably located between said second bubble layer and said intervening inner foil or metalized film as to define at least one more inner insulative air chamber.

In further embodiments, an assembly as hereinabove defined comprises said first bubble layer being a double bubble layer.

In further embodiments, an assembly as hereinabove defined comprises said second bubble layer being a double bubble layer.

Most preferably, the outer faces of the first metalized films and the outer face of the second metalized films each have a lacquer coating.

In further embodiments, assemblies as hereinabove defined comprises the metalized film being aluminized PET and the aluminum laminated polymer is aluminum foil laminated to polyethylene.

The assemblies typically have bubble spacers to provide an air spaces having a thickness selected from 0.5 cm to 3 cm.

In further embodiments, an assembly as hereinabove defined comprises spacers having a width selected from 5 cm to 20 cm.

In further embodiments, an assembly as hereinabove defined comprises the inner insulative air chambers having a cross-section defined as a height selected from 0.5 to 3 cm by a width selected from 5 cm to 20 cm.

In a further aspect, the invention provides a method of thermally insulating an object comprising suitably locating a foil or metalized polymeric film reflective insulation bubble pack assembly, as hereinabove defined, adjacent said object.

In one embodiment, the invention provides a method as hereinabove defined wherein the object is selected from an article to be packaged, a vehicle and a residential, commercial and industrial building and establishment.

In another embodiment, the invention provides a method as hereinabove defined wherein said object is metal ducting, pipes and the like located in residential, commercial and industrial buildings and establishment as air passages.

In a yet further aspect, the invention provides an object thermally insulated with a foil or metalized polymeric film reflective insulation bubble pack assembly as hereinabove defined.

In a further embodiment, the invention provides an object as hereinabove defined having a location selected from the group consisting of a frame structure, wall, crawl space, ceiling, wrapping around water heaters and pipes within said building or establishment, wherein within or at said location said insulation material is located.

In a further embodiment, the invention provides a thermally insulated object as hereinabove defined wherein said object is metal ducting, pipe and the like.

In most preferred embodiments the bubble pack assembly is adjacent but spaced apart from the sides of the object, particularly the metal ducting, pipes and the like.

In a further aspect, the invention provides a reflective bubble pack assembly as hereinabove defined having an external outer layer and a plurality of external spacers adhered to said outer layer at suitable locations intermittent of said outer layer.

A method of thermally insulating metal ducting and pipes in a residential, commercial and industrial building or establishment comprising suitably locating a metal foil or metalized polymeric film reflective insulation bubble pack assembly having a plurality of external spacers as hereinabove defined adjacent said metal ducting and pipe.

In a still yet further aspect, the invention provides an object thermally insulated with a metal foil or metalized polymeric film reflective insulation bubble pack assembly having a plurality of external spacers as hereinabove defined.

### BRIEF DESCRIPTION OF THE DRAWINGS

In order that the invention may be better understood, preferred embodiments will now be described by way of example only, wherein

FIGS. 1 to 3 represent cross-sectional views of foil or metalized polymeric film reflective insulation bubble pack assemblies, according to the invention;

FIGS. 4A and 4B are diagrammatic perspective views of a metal duct insulated with a bubble pack assembly, according to the invention;

FIGS. 5 to 16 are diagrammatic cross-sectional exploded views of various bubble pack assemblies according to the invention; and wherein the same numerals denote like parts.

### DETAILED DESCRIPTION OF PREFERRED EMBODIMENTS

With reference to FIG. 1, this shows generally as 10 a bubble pack layer 12 having an inner face 14 and an outer face 16 laminated to the inner face 18 of a metalized film 20, which also has an outer face 22.

Assembly 10 also has a bubble pack layer 24 having an inner face 26 and an outer face 28 to which face 28 in laminated at the inner face 30 of a metalized film 32, which also has an outer face 34.

Inner face 26 is laminated to a face 36 of an intervening inner metalized film 38 at face 40 at the edges thereof by means of bubble spacers 42 and 44, as to define an insulative air chamber 46 between bubble layer 12, inner metalized film 36 and spacers 42, 44.

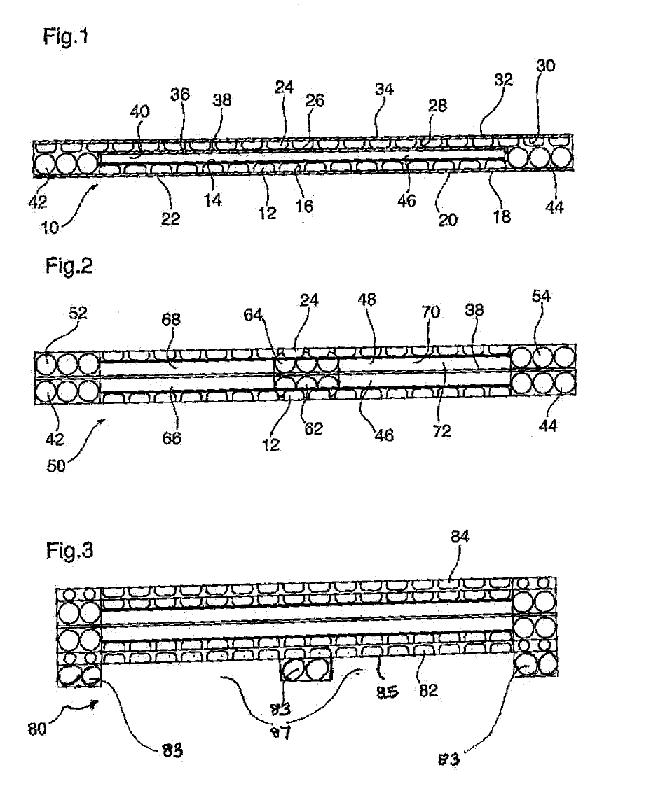

In an alternative embodiment shown in FIG. 2, generally as 50, bubble pack layer 24 is not laminated to intervening inner metalized film 38 but separated therefrom at the edges thereof by bubble spacers 52, 54 to define an insulative air chamber 48 between layer 12, inner metalized film 38 and spacers 52, 54.

In the embodiments shown, metalized films 18, 30 and 38 are aluminized PET and the bubble pack layers 12 and 24 are formed of polyethylene.

In a yet further embodiment, the embodiment described with reference to FIG. 2 is provided with further bubble spacers 62, 64 intermittent between spacers 42, 44 and 52, 54 as to define pairs of inner insulative air chambers 66, 68, 70, 72. An interspacer distance selected from 15 cm to 35 cm, preferably about 25 cm, is preferred.

In alternative embodiments, additional bubble spacers may be present between the edge spacers suitably located intermittent of the width of the assembly to separate bubble packs 12, 24 one from the other through the intervening inner metalized film 38 to provide a further plurality of inner insulative air chambers (not shown). The bubble spacers are of a suitable width to provide a suitable strong bonding to the bubble layers and the intervening inner metalizing film.

The bubble spacers are of any suitable thickness or height to provide a suitable insulative air chamber inter bubble pack film-intervening inner metalized layer distance. A bubble spacer thickness selected from 0.5 cm to 3 cm provides a preferred air chamber dimension.

In alternative embodiments, one or both of bubble pack layers 12, 24 may be constituted as double bubble packs. FIG. 3 shows preferably as 80 a modified FIG. 2 embodiment having double bubble packs 82, 84.

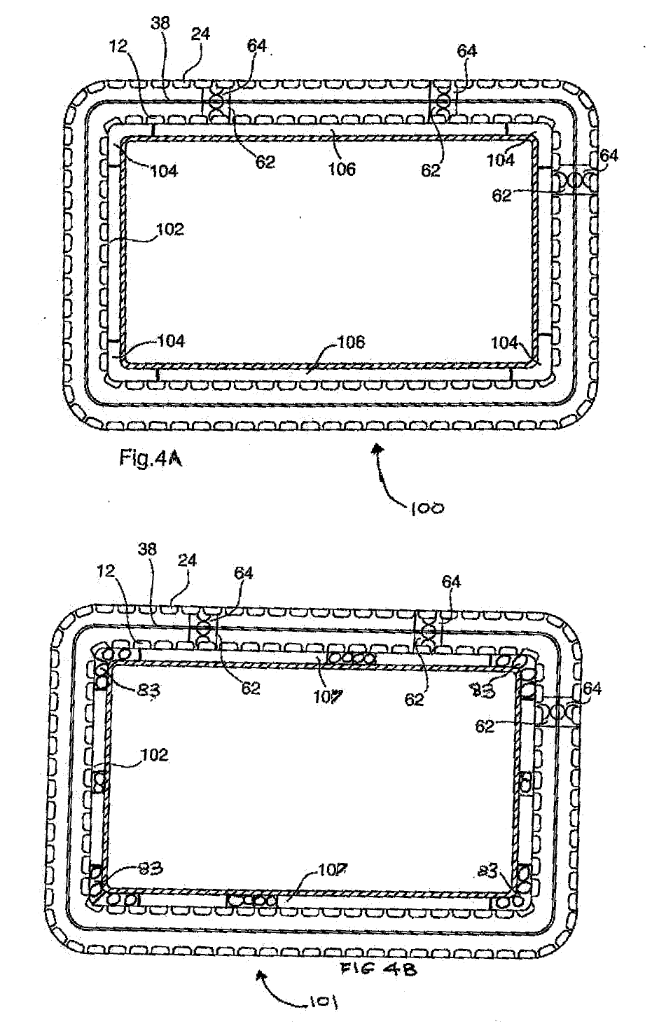

Bubble pack assembly 3 also has a plurality of external spacers 83 adhered to intermittent of outer layer 85 to define with layer 85 open cavities 87, which when wrapped around an air duct 102 (FIG. 4B) provides an insulative air chamber between the bubble pack assembly and air duct 102 (FIG. 4B).

In alternative embodiments, the intervening inner metalized layer may be substituted with a metal foil, preferably, of aluminum.

The outer faces 22, 34 of metalized films 18, 30, respectively, have a lacquer coating.

FIG. 4A shows generally as 100, in part, an air duct 102 insulated with a bubble pack assembly wrapping described with reference to FIG. 2. and having polystyrene corner pieces 104 to provide an air space 106 between the wrapping and duct 102.

FIG. 4B shows generally as 101, in part, an air duct 102 insulated with a bubble pack assembly wrapping described with reference to FIG. 3 to provide insulative air chamber 107.

### EXAMPLES

In FIGS. 5 to 16 the following numerals denote the following films comprising individual bubble packs denoted as follows.

“A” is constituted as
110 lacquer on
112 aluminized PET laminated to
114 1.2 ml PE film, laminated to
116 2 ml PE bubble, laminated to
114 laminated to
112 coated by
110
“B” is constituted as
110
112
114
116
114
“C” is constituted as
110
112
114
116
“D” is constituted as
110
112
“E” is constituted as a double bubble
110
112
114
116
114
116
114
112
110 and
118 denotes a spacer; and
PE denotes polyethylene.

FIGS. 5 to 16 represent metalized polymeric film insulation bubble pack assemblies according to the invention constituted by individual bubble packs according to the above “A” to “E” notations.

FIG. 5 represents a triple “A” double spacer assembly with the inner coated metalized faces of 112 facing each other. Suitable spacer sizes are selected from about 0.5 cm-2.5 cm.

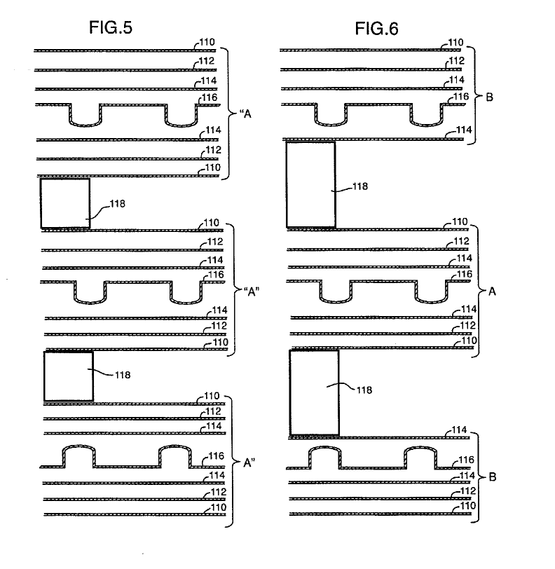

FIG. 6 represents a B-A-B double spacer arrangement.

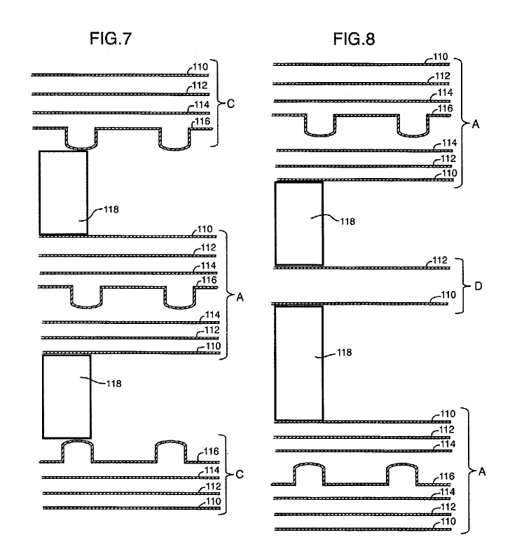

FIG. 7 represents a C-A-C double spacer arrangement.

FIG. 8 represents a A-D-A double spacer arrangement.

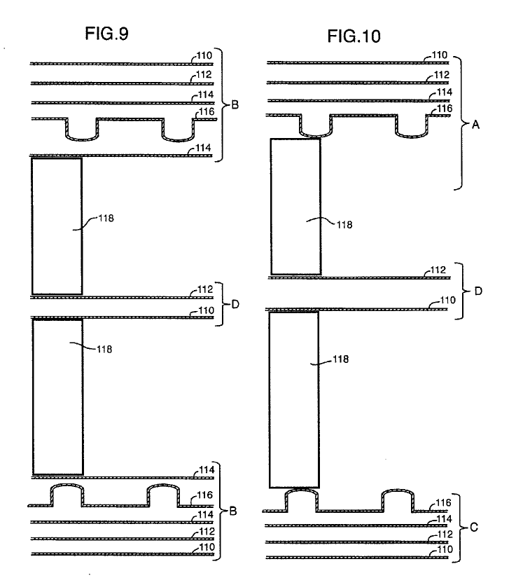

FIG. 9 represents a B-D-B double spacer arrangement.

FIG. 10 represents a C-D-C double spacer arrangement.

FIG. 11 represents an A-A single spacer arrangement.

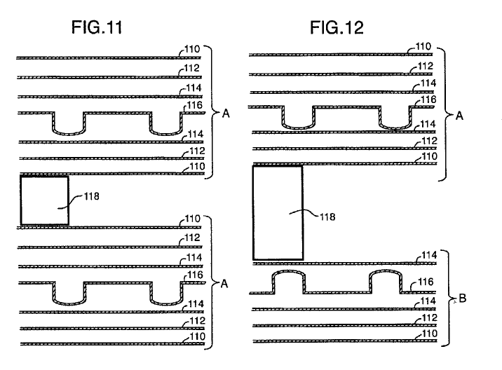

FIG. 12 represents an A-B single spacer arrangement.

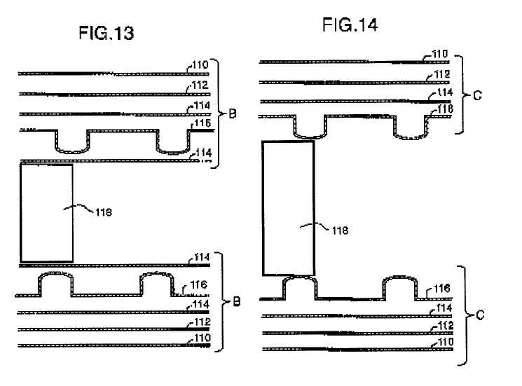

FIG. 13 represents a B-B single spacer arrangement.

FIG. 14 represents a C-C single spacer arrangement.

FIG. 15 represents a D-A-D double spacer arrangement.

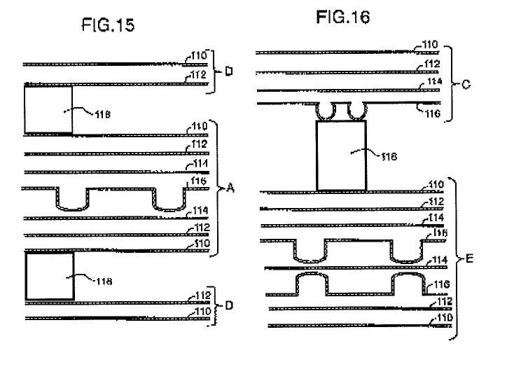

FIG. 16 represents a D-E double bubble double spacer arrangement.

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A reflective metal polymeric insulation bubble pack assembly comprising a first reflective metal bubble pack; a second reflective metal bubble pack; and a first plurality of intervening bubble spaces suitably located between said first and said second bubble packs as to define at least one inner insulative air chamber between said first and second bubble packs.

2. An assembly as claimed in claim 1 comprising
said first reflective metal bubble pack;
said second reflective metal bubble pack;
said first plurality of intervening bubble spacers;
a third reflective metal bubble pack; and
a second plurality of intervening bubble spacers suitably located between said second bubble pack and said third bubble pack as to define at least one inner insulative air chamber between said second and said third bubble packs.

3. A bubble pack assembly as claimed in claim 1 wherein each of said reflective metal bubble packs comprise a metalized polymer film or a metal foil polymer laminate.

4. A bubble pack assembly as claimed in claim 2 wherein each of said reflective metal bubble packs comprise a metalized polymer film or a metal foil polymer laminate.

5. An assembly as claimed in claim 1 wherein said first reflective metal bubble pack and said second reflective metal bubble pack are independently selected from the group consisting of
(A) a bubble pack comprising a bubble film having a first face and a second face; a first film laminated to said first face; a second film laminated to said second face; and a first metalized film laminated to said first film;
(B) a bubble pack comprising a bubble film having a first face and a second face; a first film laminated to said first face; a second film laminated to said second face; a first metalized film laminated to said first film; and a second metalized film laminated to said second film;
(C) a bubble pack comprising a bubble film having a first face and a second face; a first film laminated to said first face; and a metalized film laminated to said first film;
(D) a bubble pack comprising
(i) a first bubble film having a first bubble first face and a first bubble second face; a first film laminated to said first bubble first face and a first bubble second face; and a first metalized film laminated to said first film laminated to said first bubble first face;
(ii) a second bubble film having a second bubble first face and a second bubble second face; a second film laminated to said second bubble first face; and a second metalized film laminated to said second bubble second face; and
(iii) an intervening film laminated to said first bubble second face and to second bubble first face whereby said first bubble film and said second bubble film are laminated one to the other.

6. An assembly as claimed in claim 1 wherein said first reflective metal bubble pack and said second reflective metal bubble pack are independently selected from the group consisting of
(A) a bubble pack comprising a bubble film having a first face and a second face; a first film laminated to said first face; a second film laminated to said second face; and a first metal foil laminated to said first film;
(B) a bubble pack comprising a bubble film having a first face and a second face; a first film laminated to said first face; a second film laminated to said second face; a first metal foil laminated to said first film; and a second metal foil laminated to said second film;
(C) a bubble pack comprising a bubble film having a first face and a second face; a first film laminated to said first face; and a metal foil laminated to said first film;
(D) a bubble pack comprising
(i) a first bubble film having a first bubble first face and a first bubble second face; a first film laminated to said first bubble first face and a first bubble second face; and a first metal foil laminated to said first bubble first face;
(ii) a second bubble film having a second bubble first face and a second bubble second face; a second film laminated to said second bubble first face; and a second metal foil laminated to said second bubble second face; and
(iii) an intervening film laminated to said first bubble second face and to second bubble first face whereby said first bubble film and said second bubble film are laminated one to the other.

7. A bubble pack assembly as claimed in claim 1 further comprising at least one intervening inner metal foil or metalized film disposed within at least one of said at least one inner insulative air chamber between said first and second bubble packs.

8. A metalized polymeric film reflective insulation bubble pack assembly comprising
(A) a first bubble layer having an inner face and an outer face;
a first film selected from a metalized film and metal foil laminate having an inner face laminated to said outer face of said first bubble layer and an outer face,
(B) a second bubble layer having an inner face and an outer face, a second film selected from a metalized film and a metal laminate having an inner face laminated to said outer face of said second bubble layer, and an outer face,
(C) an intervening inner metal foil or metalized film having a first face and a second face disposed between said first bubble layer and said second bubble layer,
(D) a pair of bubble spacers suitably located between said inner face of said first bubble layer and said first face of said intervening inner metalized film as to define an inner insulative air chamber between said first bubble layer, said intervening inner metalized film and said spacers.

9. An assembly as claimed in claim 8 wherein said inner face of said second bubble layer is laminated to said second face of said intervening foil or metalized film.

10. An assembly as claimed in claim 8 further comprising a pair of second bubble spacers suitably located between said inner face of said second bubble layer and said second face of said intervening inner foil or metalized film as to define an inner insulative air chamber between said second bubble layer, said intervening inner metallised film and said second bubble spacers.

11. An assembly as claimed in claim 8 further comprising at least one more additional spacer suitably located between said first bubble layer and said intervening inner foil or metalized film as to define at least one more inner insulative air chamber.

12. An assembly as claimed in claim 1 further comprising at least one more additional spacer suitably located between said second bubble layer and said intervening inner foil or metalized film as to define at least one more inner insulative air chamber.

13. An assembly as claimed in claim 1 wherein said first bubble layer comprises a double bubble layer.

14. An assembly as claimed in claim 1 wherein said second bubble layer comprises a double bubble layer.

15. An assembly as claimed in claim 1 wherein each of said outer face of said first metalized film and said outer face of said second metalized film has a lacquer coating.

16. An assembly as claimed in claim 1 wherein said metalized film comprises aluminized PET.

17. An assembly as claimed in claim 1 having an external outer layer and a plurality of external spacers adhered to said outer layer at suitable locations intermittent of said outer layer.

18. A method of thermally insulating metal ducting and pipes in a residential, commercial and industrial building or establishment comprising suitably locating a metal foil or metalized polymeric film reflective insulation bubble pack assembly as defined in claim 1 adjacent said metal ducting and pipes.

19. A method of thermally insulating metal ducting and pipes in a residential, commercial and industrial building or establishment comprising suitably locating a metal foil or metalized polymeric film reflective insulation bubble pack assembly as defined in claim 1 having an external outer layer and a plurality of external spacers adhered to said outer layer at suitable locations intermittent of said outer layer adjacent said metal ducting and pipes.

20. An object thermally insulated with a metal foil or metalized polymeric film reflective insulation bubble pack assembly as defined in claim 1.

21. An object thermally insulated with a metal foil or metalized polymeric film reflective insulation bubble pack assembly as defined in claim 1 having an external outer layer and a plurality of external spacers adhered to said outer layer at suitable locations intermittent of said outer layer.
